(19) United States
(12) Patent Application Publication
(10) Pub. No.: US 2016/0340874 A1
(43) Pub. Date: Nov. 24, 2016

(54) POSITION RESTORING AND WATER SPLITTING SHOWER ARM AND METHOD OF IMPLEMENTING THE SAME

(71) Applicant: Xiamen Runner Industrial Corporation, Xiamen (CN)

(72) Inventors: Yuan-shan Liang, Xiamen (CN); Wen-Kun Lin, Xiamen (CN); Sheng-chao Dai, Xiamen (CN)

(21) Appl. No.: 15/156,116

(22) Filed: May 16, 2016

(30) Foreign Application Priority Data
May 18, 2015 (CN) 201510249475.9

(51) Int. Cl. E03C 1/02; F16K 31/00; B05B 1/18; F16K 11/044; E03C 1/06; B05B 15/06

(52) U.S. Cl. CPC E03C 1/025; E03C 1/06; B05B 15/066; B05B 1/185; F16K 11/044; F16K 31/003

(57) ABSTRACT

A position restoring and water splitting shower arm and a method of implementing the same. The shower arm comprises: a tube body and a switch valve. The tube body is provided with a water input port and a first water output port, while a second water output port is disposed on a middle section of the tube body. The switch valve is disposed vertically in the tube body, to switch connection and communication between the water input port and a first water output port, or between the water input port and the second water output port. The switch valve includes a valve seat; and a gravitation valve core disposed in the valve seat, with its one end provided with a valve core head, used to block the second water output port or the valve seat upper port.

### BACKGROUND OF THE INVENTION

Field of the Invention

The present invention relates to a shower arm, and in particular to a position restoring and water splitting shower arm and method of implementing the same.

The Prior Arts

In general, a shower head has the shape of a lotus seedpod, and is used in a bath room for taking a shower. While a shower arm is a tube body used for connecting a wall piece and a shower head. Presently, a shower arm is used only for transporting water, and it does not have position restoring and water splitting capabilities.

Therefore, presently, the design and performance of the shower arm is not quite satisfactory, and it leaves much room for improvement.

### SUMMARY OF THE INVENTION

In view of the problems and drawbacks of the prior art, the present invention provides a position restoring and water splitting shower arm and method of implementing the same, to overcome the shortcomings of the prior art.

The present invention provides a position restoring and water splitting shower arm, comprising: a tube body and a switch valve. The tube body is provided with a water input port and a first water output port, while a second water output port is disposed on a middle section of the tube body. The switch valve is disposed vertically in the tube body, to switch connection and communication between the water input port and a first water output port, or between the water input port and the second water output port. The switch valve includes: a valve seat; and a gravitation valve core, disposed in the valve seat, with its one end provided with a valve core head, used to block the second water output port or the valve seat upper port.

In an aspect of the present invention, the first water output port is a shower head water output port.

In another aspect of the present invention, the second water output port is a shower water output port, disposed on surface of the middle section of the tube body.

In a further aspect of the present invention, the valve seat is fixed in the tube body and on a valve cavity facing the second water output port; a water input wall and a water output wall are provided in the valve cavity; a water input through hole is provided on the water input wall in communication with the water input port; a water output through hole is provided in the water output wall in communication with the first water output port; a water passage partition cavity is provided between the second water output port and an upper surface of the valve seat, in communication with the water input through hole.

In yet another aspect of the present invention, a gravitation push button is disposed at a lower end of the gravitation valve core.

The present invention also provides a position restoring and water splitting shower arm implementation method, comprising a tube body, provided with a water input port and a first water output port, while a second water output port is disposed on a middle section of the tube body; and a switch valve, disposed vertically in the tube body, to switch connection and communication between the water input port and a first water output port, or between the water input port and the second water output port, including: a valve seat, and a gravitation valve core, disposed in the valve seat, with its one end provided with a valve core head, used to block the second water output port or the valve seat upper port; such that the method includes following steps:

When water flows into the tube body from the water input port through the switch valve, under action of gravitation force, the valve core head of the gravitation valve core blocks the valve seat, so that water is kept from flowing to the first water output port, while water is made to flow to the second water output port, this approach is referred to as shower water output mode.

When the gravitation valve core is pushed upward, the valve core head of the gravitation valve core blocks the second water output port, meanwhile the gravitation valve core is kept from dropping downward under action of back pressure of water flow, so that water flows to the first water output port, this approach is referred to as shower head water output mode.

When a main switch for water input is closed so that water pressure of the shower arm is stopped, at this time the gravitation valve core loses the back pressure of water flow, and under action of gravitation force, the gravitation valve core will drop downward, and return to a preset mode of shower water output.

During installation, the gravitation valve core is penetrated downward from the upper end of the valve seat (with the valve core head of the gravitation valve core facing upward), then the lower end of the gravitation valve core is fixed through fastening tight the gravitation push button.

Compared with the Prior Art, the present invention has the advantages that, it is simple in construction, novel in design, thus it is favorable to implement the position restoring and water splitting functions of the shower arm.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a perspective view of a position restoring and water splitting shower arm according to an embodiment of the present invention;

FIG. 2 is an exploded view of a position restoring and water splitting shower arm according to an embodiment of the present invention;

FIG. 3 is a cross section view of a position restoring and water splitting shower arm in a shower head water output mode according to an embodiment of the present invention; and

FIG. 4 is a cross section view of a position restoring and water splitting shower arm in a shower water output mode according to an embodiment of the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

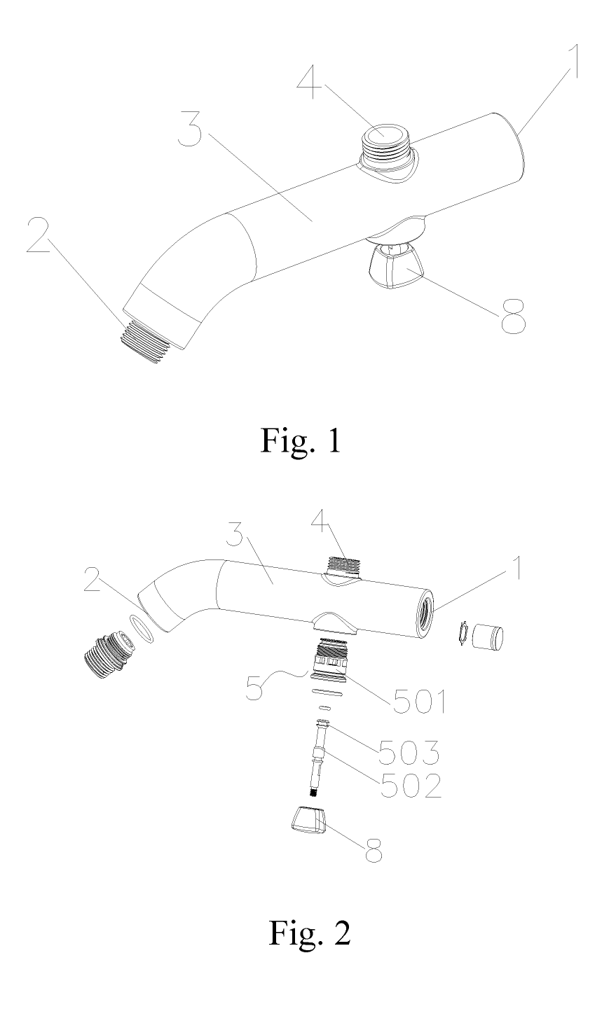

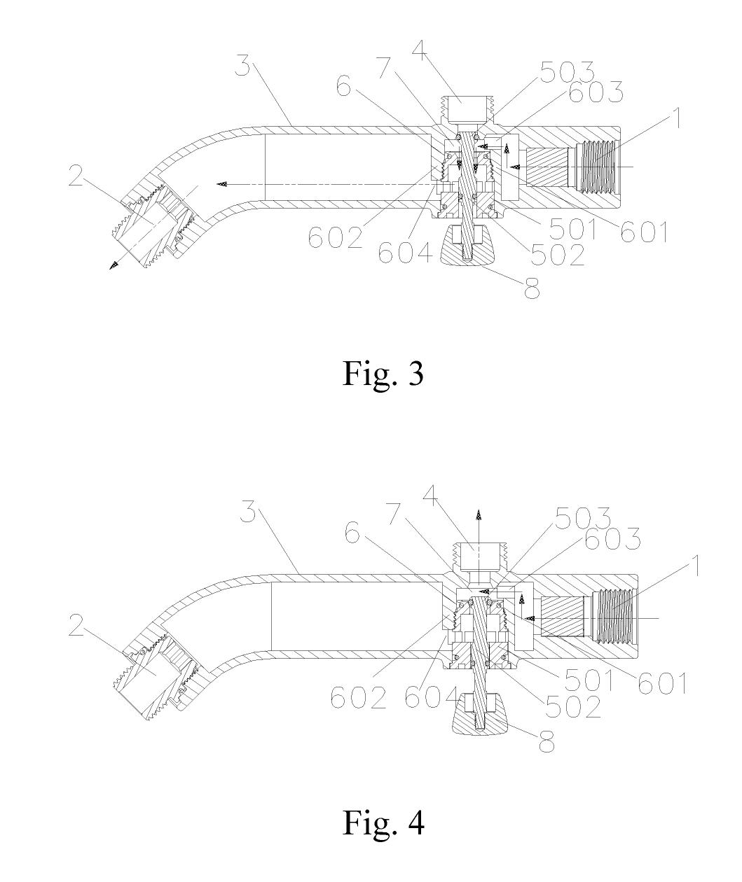

Refer to FIGS. 1 to 4 respectively for a perspective view of a position restoring and water splitting shower arm according to an embodiment of the present invention; an exploded view of a position restoring and water splitting shower arm according to an embodiment of the present invention; a cross section view of a position restoring and water splitting shower arm in a shower head water output mode according to an embodiment of the present invention; and a cross section view of a position restoring and water splitting shower arm in a shower water output mode according to an embodiment of the present invention.

As shown in FIGS. 1 to 4, the present invention provides a position restoring and water splitting shower arm, comprising: a tube body 3 and a switch valve 5. The tube body 3 is provided with a water input port 1 and a first water output port 2, while a second water output port 4 is disposed on a middle section of the tube body 3. The switch valve 5 is disposed vertically in the tube body 3, to switch connection and communication between the water input port 1 and a first water output port 2, or between the water input port 1 and the second water output port 4. The switch valve 5 includes: a valve seat 50; and a gravitation valve core 502, disposed in the valve seat 501, with its one end provided with a valve core head 503, used to block the second water output port 4 or the valve seat 501 upper port.

In an embodiment of the present invention, for design requirement, the first water output port 2 is a shower head water output port, while the second water output port 4 is a shower water output port, disposed on surface of the middle section of the tube body 3.

In an embodiment of the present invention, the valve seat 501 is fixed in the tube body 3 and on a valve cavity 6 facing the second water output port 4; a water input wall and a water output wall are provided in the valve cavity 6; a water input through hole is provided on the water input wall in communication with the water input port 1; a water output through hole is provided on the water output wall in communication with the first water output port 2; a water passage partition cavity is provided between the second water output port 4 and an upper surface of the valve seat 501, in communication with the water input through hole.

In an embodiment of the present invention, a gravitation push button 8 is disposed at a lower end of the gravitation valve core 502, to improve the position restoration capability.

The principles of implementing the position restoring and water splitting shower arm are as follows:

When water flows into the tube body 3 from the water input port 1 through the switch valve 5, under action of gravitation force, the valve core head 503 of the gravitation valve core 502 blocks the valve seat 501, so that water is kept from flowing to the first water output port 2, while water is made to flow to the second water output port 4, this approach is referred to as shower water output mode.

When the gravitation valve core 502 is pushed upward, the valve core head 503 of the gravitation valve core 502 blocks the second water output port 4, meanwhile the gravitation valve core 502 is kept from dropping downward under action of back pressure of water flow, so that water flows to the first water output port 2, this approach is referred to as shower head water output mode.

When a main switch for water input is closed so that water pressure of the shower arm is stopped, at this time the gravitation valve core 502 loses the back pressure of water flow, and under action of gravitation force, the gravitation valve core 502 will drop downward, and return to a preset mode of shower water output.

Compared with the Prior Art, the present invention has the advantages that, it is simple in construction, novel in design, thus it is favorable to implement and realize the position restoring and water splitting functions of the shower arm.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A position restoring and water splitting shower arm, comprising:
a tube body, provided with a water input port and a first water output port, while a second water output port is disposed on a middle section of the tube body; and
a switch valve, disposed vertically in the tube body, to switch connection and communication between the water input port and a first water output port, or between the water input port and the second water output port, including:
a valve seat, and
a gravitation valve core, disposed in the valve seat, with its one end provided with a valve core head, used to block the second water output port or the valve seat upper port.

2. The position restoring and water splitting shower arm as claimed in claim 1, wherein the first water output port is a shower head water output port.

3. The position restoring and water splitting shower arm as claimed in claim 1, wherein the second water output port is a shower water output port, disposed on surface of the middle section of the tube body.

4. The position restoring and water splitting shower arm as claimed in claim 1, wherein the valve seat is fixed in the tube body and on a valve cavity facing the second water output port; a water input wall and a water output wall are provided in the valve cavity; a water input through hole is provided on the water input wall in communication with the water input port; a water output through hole is provided on the water output wall in communication with the first water output port; and a water passage partition cavity is provided between the second water output port and an upper surface of the valve seat, in communication with the water input through hole.

5. The position restoring and water splitting shower arm as claimed in claim 1, further comprising: a gravitation push button, disposed at a lower end of the gravitation valve core.

6. A position restoring and water splitting shower arm implementation method, comprising a tube body, provided with a water input port and a first water output port, while a second water output port is disposed on a middle section of the tube body; and a switch valve, disposed vertically in the tube body, to switch connection and communication between the water input port and a first water output port, or between the water input port and the second water output port, including: a valve seat, a gravitation valve core, disposed in the valve seat, with its one end provided with a valve core head, used to block the second water output port or the valve seat upper port; such that the method includes following steps:
when water flows into the tube body from the water input port through the switch valve, under action of gravitation force, the valve core head of the gravitation valve core blocks the valve seat, so that water is kept from flowing to the first water output port, while water is made to flow to the second water output port, this approach is referred to as shower water output mode;
when the gravitation valve core is pushed upward, the valve core head of the gravitation valve core blocks the second water output port, meanwhile the gravitation valve core is kept from dropping downward under action of back pressure of water flow, so that water flows to the first water output port, this approach is referred to as shower head water output mode; and
when a main switch for water input is closed so that water pressure of the shower arm is stopped, at this time the gravitation valve core loses the back pressure of water flow, and under action of gravitation force, the gravitation valve core will drop downward, and return to the preset shower water output mode.

7. The position restoring and water splitting shower arm implementation method as claimed in claim 6, wherein the first water output port is a shower head water output port.

8. The position restoring and water splitting shower arm implementation method as claimed in claim 6, wherein the second water output port is a shower water output port, disposed on surface of the middle section of the tube body.

9. The position restoring and water splitting shower arm implementation method as claimed in claim 6, wherein the valve seat is fixed in the tube body and on a valve cavity facing the second water output port; a water input wall and a water output wall are provided in the valve cavity; a water input through hole is provided on the water input wall in communication with the water input port; a water output through hole is provided on the water output wall in communication with the first water output port; and a water passage partition cavity is provided between the second water output port and an upper surface of the valve seat, in communication with the water input through hole.

10. The position restoring and water splitting shower arm implementation method as claimed in claim 6, wherein the position restoring and water splitting shower arm further comprises a gravitation push button, disposed at a lower end of the gravitation valve core.
